(19) United States
(12) Patent Application Publication
(10) Pub. No.: US 2026/0266305 A1
(43) Pub. Date: Sep. 10, 2026

(54) MAGNETIC LEVITATION DEVICE AND PUMP UNIT

(71) Applicant: Levitronix GmbH, Zurich (CH)

(72) Inventors: Daniel STEINERT, Bulach (CH); Thomas HOLENSTEIN, Umiken (CH)

(21) Appl. No.: 19/547,014

(22) Filed: Feb. 23, 2026

(30) Foreign Application Priority Data
Mar. 5, 2025 (EP) 25161949.0

(51) Int. Cl. F04D 29/048; F16C 32/04

(52) U.S. Cl. CPC F04D 29/048; F16C 32/0493; F16C 2360/00

(57) ABSTRACT

A magnetic levitation includes a stator having a cup-shaped recess and coil cores. The coil cords have a connecting leg and a pole piece, the connecting leg extending from a first end to a second end, the first end abutting a back iron. The pole piece has a second contact surface abutting the second end of the connecting leg and extends from the second contact surface in a radial direction to an end face, the radial direction being perpendicular to the axial direction. The end faces for the pole pieces arranged around the cup-shaped recess and a concentrated winding arranged on the connecting leg, the concentrated winding surrounding the connecting leg and extending obliquely with respect to the axial direction, such that the second end of the connecting leg is at a smaller distance from the cup-shaped recess in the radial direction than the first end.

### CROSS-REFERENCE TO RELATED APPLICATIONS

This application claim priority to European Application No. 25161949.0, filed on Mar. 5, 2025. The entire contents of which are hereby incorporated herein by reference.

### TECHNICAL FIELD

The disclosure relates to a magnetic levitation device and a pump unit having such a magnetic levitation device.

### BACKGROUND

Generally magnetic levitation devices for the contactless magnetic levitation of a rotor have the advantage that they manage without mechanical bearings for the rotor. The rotor is levitated or stabilized by magnetic forces which are generated by a stator of the magnetic levitation device. Due to the absence of mechanical bearings, such magnetic levitation devices are suitable in particular for pumping, mixing, centrifuging or stirring devices with which very sensitive substances are conveyed, for example blood pumps, or in which very high demands are placed on the purity, for example in the pharmaceutical industry or in the biotechnological industry, or with which abrasive or aggressive substances are conveyed which would destroy mechanical bearings very quickly, for example pumps or mixers for slurry, sulfuric acid, phosphoric acid or other chemicals in the semiconductor industry.

In the biotechnological industry, such magnetic levitation devices are used for example in connection with bioreactors, for example in the case of centrifugal pumps for conveying the fluids into or out of the bioreactor, or in the case of mixing devices which mix the fluids in the bioreactor. In the semiconductor industry, such magnetic levitation devices are used not only for conveying aggressive or abrasive substances, but also for example for rotation devices with which wafers are rotated.

It is also known to use magnetic levitation devices for viscometers.

### SUMMARY

An advantageous configuration known per se of a magnetic levitation device is the configuration in temple construction. Such a magnetic levitation device is illustrated in FIG. 1. The reference signs in FIG. 1 are each provided with an inverted comma in order to make it clear that these components belong to the state of the art.

The characteristic of temple construction is that the stator 2′ of the magnetic levitation device 1′ has a plurality of coil cores 25′, each of which comprises a longitudinal leg 26′, which extends from a first end 261′ in an axial direction A′ to a second end 262′. In this case, the axial direction A′ means that direction which is defined by the desired axis of rotation of the rotor 3′, which is levitated with the magnetic levitation device 1′. The desired axis of rotation is that axis of rotation about which the rotor 3′ rotates in the operating state when it is in a centered and non-tilted position with respect to the stator 2′. Each coil core 25′ comprises, in addition to the longitudinal leg 26′, a transverse leg 27′, also called pole piece, which is arranged in each case at the second end of the longitudinal leg 262′, and which extends in the radial direction R′—usually inward—, wherein the radial direction R′ is perpendicular to the axial direction A′. The transverse leg 27′ thus extends substantially at right angles to the longitudinal leg 26′. The coil cores 25′ each have the shape of an L, wherein the transverse legs 27′ form the short legs of the L. The rotor 3′ to be levitated is then arranged between the transverse legs 27′.

The plurality of longitudinal legs 26′, which extend in the axial direction A′, and which are reminiscent of the columns of a temple has given this construction its name.

In a configuration, for which an example is shown in FIG. 1, the stator 3′ of the magnetic levitation device 1′ has, for example, six coil cores 25′, which are arranged circularly and equidistantly around a cup-shaped recess (not explicitly illustrated in FIG. 1) into which the rotor 3′ can be inserted. The first ends of the longitudinal legs are usually connected in a circumferential direction by a back iron 28′, which serves to conduct the magnetic flux.

The rotor 3′ to be levitated comprises a magnetically active core 31′, for example a permanent magnetic disk or a permanent magnetic ring, which is arranged between the radially inner ends of the transverse legs 27′ and rotates about the axial direction A′ in the operating state, wherein the rotor 3′ is levitated magnetically in a contactless manner with respect to the stator 2′.

For such magnetic levitation devices 1′, it is not necessarily the case that the magnetically active core of the rotor 31′ must be of permanent magnetic design. Such designs are also known, in which the magnetically active core 31′ of the rotor 3′ is designed free of permanent magnets, that is to say without permanent magnets. The magnetically active core of the rotor 31′ is then, for example, of ferromagnetic design and consists, for example, of iron, nickel-iron, cobalt-iron, silicon-iron, Mu-metal or another ferromagnetic material.

Furthermore, designs are possible, in which the magnetically active core of the rotor 31′ comprises both ferromagnetic materials and permanent magnetic materials. For example, permanent magnets can be placed or inserted into a ferromagnetic main body. Such designs are advantageous, for example, if, in the case of large rotors, it is intended to reduce the costs by saving permanent magnetic material.

In order to generate the electromagnetic fields necessary for the contactless magnetic levitation of the rotor 3′, the longitudinal legs 26′ carry windings 61′. The windings 61′ are, for example, designed such that a concentrated winding 61′ is wound around each longitudinal leg 26′, that is to say that the coil axis of each concentrated winding 61′ extends in each case in the axial direction A′. In this case, it is typical for the temple construction that the coil axes of the concentrated windings 61′ run in the axial direction A′ and that the concentrated windings 61′ are not arranged in the radial plane R′, in which the rotor 3′ or the magnetically active core of the rotor 31′ is levitated in the operating state.

Designs are possible in which precisely one concentrated winding 61′ is arranged on each longitudinal leg 26′. In other designs, several concentrated windings 61′, for example precisely two, are provided on each longitudinal leg 26′. Designs are also possible in which windings 61′ are provided which are wound around two longitudinal legs 26′ which are adjacent in the circumferential direction, with the result that these two adjacent longitudinal legs 26′ are both located in the interior of the concentrated winding 61′.

The temple construction just described makes possible a well-proven magnetic levitation device 1′ which is known from the state of the art, but it has been determined that this design has potential for improvement. In the case of magnetic levitation devices 1′ in temple construction, it is difficult to provide a design that is sufficiently compact. The longitudinal legs 26′ and the concentrated windings 61′ are necessary for the operation of the magnetic levitation device 1′ in temple construction. However, these at the same time also predefine the spatial extent of the device. It is therefore not readily possible to use such a magnetic levitation device 1′ for applications which, for example on account of spatial circumstances, have little space available for the magnetic levitation device 1′. Conversely, this means that a magnetic levitation device 1′ in temple construction cannot be designed sufficiently compactly for reliable operation in some applications, or only at great expense.

Lack of compactness of the magnetic levitation device 1′ also leads to a large amount of material being required for the production of the individual components. The entire device 1′ therefore has a high weight and higher costs, which in turn can lead to it not being optimally suitable for some fields of use.

Furthermore, it is often challenging to design a magnetic levitation device 1′ in temple construction with more than six coil cores 25′. If the size of the rotor 3′ or of the magnetically active core 31′ cannot be changed, it is therefore difficult to insert, for example, two further coil cores 25′ around the cup-shaped recess 211′. Furthermore, due to the small space available, the longitudinal legs 26′ are arranged very close to one another, which can lead to stray fluxes and therefore high iron losses. A further problem which can lead to high iron losses is that long magnetic paths are produced owing to the construction of the longitudinal legs 26′. However, these are not desirable since the resulting losses must ultimately be dissipated in the form of heat and therefore the efficiency of the magnetic levitation device in temple construction falls.

Starting from this state of the art, it is therefore an object of the disclosure to propose a magnetic levitation device for the contactless magnetic levitation of a rotor with a disk-shaped or ring-shaped magnetically active core, which magnetic levitation device has a more compact construction and at the same time a higher efficiency.

Furthermore, it is an object of the disclosure to propose a pump unit having such a magnetic levitation device.

The subject matter of the disclosure meeting this object is characterized by the features disclosed herein.

According to the disclosure, a magnetic levitation device is therefore proposed for the contactless magnetic levitation of a rotor which has a disk-shaped or ring-shaped magnetically active core, wherein the magnetic levitation device comprises a stator which extends in an axial direction and has a cup-shaped recess which is arranged at an axial end of the stator and into which the rotor can be inserted. The stator has a plurality of coil cores, each of which has a connecting leg and a pole piece, wherein each connecting leg extends from a first end to a second end, wherein the first end abuts a back iron. Each pole piece has a second contact surface which abuts the second end of the connecting leg, wherein each pole piece extends from the second contact surface in a radial direction to an end face, wherein the radial direction is perpendicular to the axial direction. All end faces are arranged around the cup-shaped recess, and at least one concentrated winding is arranged on each connecting leg, which winding surrounds the respective connecting leg.

Each connecting leg extends obliquely with respect to the axial direction, with the result that the second end of each connecting leg is at a smaller distance from the cup-shaped recess in the radial direction than the first end.

In other words, the connecting leg has a radially inwardly directed extent. That is to say that the connecting leg is oriented neither parallel nor perpendicular to the axial direction. That is to say that an axis of the connecting leg encloses an angle with the axial direction which is greater than 0° and less than 90°. The angle is preferably between 20° and 60°. The axis of the connecting leg which encloses the angle with the axial direction preferably extends from a first center point of a first contact surface of the connecting leg to a second center point of a second contact surface of the connecting leg, wherein the second contact surface is arranged on the contact surface of the pole piece.

A compact magnetic levitation device is made possible by this configuration of the magnetic levitation device. It is likewise advantageous that it is possible to arrange significantly more coil cores around the cup-shaped recess than in the temple motor known from the state of the art. This ensures a wider covering, as seen in the circumferential direction, of that surface of the rotor which faces the end faces of the pole pieces by the coil cores. A better flux conduction of the magnetic field is thus achieved.

In the context of this application, a cup-shaped recess is understood to mean a recess which resembles the shape of a cup. That is to say that the cup-shaped recess has at least one diameter in the radial direction. The outer shape of the cup-shaped configuration can be designed cylindrically, conically or else by a mixture of the two shapes. The cup-shaped recess can have both a closed base and an open base or no base at all. It goes without saying that it is possible for the cup-shaped recess to also have smaller artefacts, such as, for example, openings or depressions.

In a preferred embodiment, the back iron connects the first ends of all connecting legs.

The back iron ensures the magnetic flux conduction within the magnetic levitation device.

In a preferred embodiment, the back iron is designed as a component.

In a preferred embodiment, the back iron has several segments, wherein the segments are preferably produced in a laminated manner from back iron elements which are stacked in the axial direction.

The number of segments is preferably twelve. However, embodiments are also possible in which the number is smaller, for example six or eight, or higher, for example 16 or 20.

The segmentation of the back iron is advantageous above all during production. The segments and the connecting legs and pole pieces arranged thereon can be produced individually and assembled to form the entire magnetic levitation device at the end.

The laminated configuration of the segments reduces the eddy current losses of the magnetic levitation device.

It is also possible that the back iron is not constructed from segments but is nevertheless produced in a laminated manner from back iron elements which are stacked in the axial direction.

In a preferred embodiment, all segments of the back iron are arranged abutting each other.

In a preferred embodiment, all segments of the back iron are arranged abutting each other without an air gap.

The segments each have a first segment end and a second segment end in the circumferential direction. In a preferred embodiment, the segment has a first shape at the first segment end and a second shape at the second segment end, wherein the first and second shapes are complementary shapes. In other words, the first shape is a male shape, and the second shape is the female counterpart.

This means that both shapes are designed in such a way that the first segment end can be connected to a second segment end of a first adjacent segment in a form-fitting manner and the second segment end can be connected to a first segment end of a second adjacent segment in a form-fitting manner. The first and second shapes are thus designed as two interlocking geometries. In other words, the first shape is a male shape, and the second shape is the female counterpart.

According to a preferred embodiment, the first and second shapes have a circular, semicircular, or oval design. However, other geometric shapes are also possible.

These embodiments have the advantage that a certain degree of flexibility is available when joining the individual segments together, so that they can be moved against each other, for example, if necessary. This also makes it easier to replace individual segments.

According to a preferred embodiment, the first and second shapes have a stepped shape in the axial direction, with the steps at the first and second segment ends being complementary to each other.

According to a preferred embodiment, each segment has a bore in the axial direction through the segment and/or a curvature.

A bore can serve to fix the magnetic levitation device to a foundation, e.g., a housing, using fixing means such as screws or rivets. The position of the bores is to be understood as an example and can also be arranged at other positions of the segments. Curvatures in the back iron are advantageous, for example, when the magnetic levitation device is installed in a very narrow (precisely fitting) housing. They can then be used, for example, as feed-throughs for cables or for better distribution of the casting compound so that it can flow around the entire stator.

In a preferred embodiment, the back iron bottom surface and also the back iron surface are arranged in a plane that is arranged perpendicular to the axial direction.

In a preferred embodiment, the segments form a continuous and/or composite ring that forms the back iron and is arranged perpendicular to the axial direction A.

In a preferred embodiment, the back iron has an axial upper side, wherein the first ends of the connecting legs are arranged thereon. In other words, the connecting legs are arranged on the back iron. That is to say that a first contact surface of the connecting legs at the first end extends in a radial plane, wherein the axial upper side of the back iron is in the same radial plane.

In a preferred embodiment, the back iron has a radial inner side, wherein the first ends of the connecting legs are arranged thereon. In other words, the connecting legs are arranged on the radially inner side or surface of the back iron. That is to say that the first contact surface of the connecting legs at the first end extends predominantly in a plane which is arranged perpendicular to the radial direction and is the first contact surface with respect to the radial inner side of the back iron.

In a preferred embodiment, the stator has twelve coil cores, and the rotor has a plurality of rotor poles, preferably eight rotor poles, wherein the rotor poles are configured as four pole pairs.

For the embodiment in which the back iron is not segmented, the twelve coil cores are all arranged on the one back iron. It is understood that the number of twelve stator poles is to be understood purely as an example, there can also be more or fewer than twelve stator poles.

For the embodiment with the segmented back iron, this means that there are preferably also twelve segments of the back iron on which the twelve coil cores are arranged. In other words, it is preferred in this case that a coil core always forms a unit with a segment which, arranged in the circumferential direction, forms the back iron with coil cores arranged thereon.

However, it is also likewise possible for more than one coil core to be arranged on a segment of the back iron. Thus, for example, in this embodiment, it is also possible for six segments, wherein two coil cores are arranged on each segment, to form the stator which has twelve coil cores.

In a preferred embodiment, the back iron bottom surface and also the back iron surface are each arranged in a plane that is arranged perpendicular to the axial direction.

In a preferred embodiment, the segments form a continuous and/or composite ring that forms the back iron and is arranged perpendicular to the axial direction A.

The number of coil cores and of the rotor poles can also be smaller or higher than the said twelve coil cores or eight rotor poles. Likewise, the number of coil cores per segment can be greater or smaller than the said two coil cores.

In a preferred embodiment, the at least one concentrated winding is of conical design.

Possible in this case are all types of winding known to the person skilled in the art from the state of the art for conical windings, and also, for example, a stepped conical winding. Likewise, all winding techniques known from the state of the art are meant, in which a high degree of compactness and a high filling factor are achieved by the layer construction with good producibility at the same time. These include, for example, orthocyclic winding, wire cross-sectional configuration such as, for example, round wire, flat wire or rectangular wire, placement of the winding starts and ends. Accordingly, winding strands can also be routed in series or in parallel and optionally twisted. Corresponding insulation measures such as coil holders and insulation layers are also self-evident.

Furthermore, it is preferred that the at least one concentrated winding has a lower end and an upper end, wherein the lower end faces the first end of the connecting leg and the upper end faces the second end of the connecting leg, wherein the at least one concentrated winding has a first outer diameter at the lower end and a second outer diameter at the upper end, wherein the first outer diameter is greater than the second outer diameter.

This is advantageous since a flat surface of the stator is achieved at an axial end of the stator. Without the conical configuration of the concentrated winding, a flat surface would not be present since otherwise the at least one concentrated winding would have an extent in the axial direction which, as seen in the axial direction, is higher than the extent of a surface of the pole piece. In other words, the highest point in the axial direction of the concentrated winding must not exceed the highest point in the axial direction of the pole piece. These two can lie at maximum in one and the same radial plane.

That is to say, a stator housing which encloses the stator thus has a flat surface at the axial upper end of the stator. In other words, the axially upper surface of the stator housing is located in a radial plane. This is advantageous for the magnetic levitation device since a better interaction between stator and rotor is thereby achieved. The rotor or the magnetically active core has a radial central plane which coincides with a radial central plane of the pole piece. That is to say that the axial position of the rotor when the latter is inserted into the cup-shaped recess is defined by the axial position of the pole pieces. On account of the configuration according to the disclosure of the magnetic levitation device, an offset between the pole piece or the pole piece surface and the back iron or a back iron surface is achieved in the axial direction. As a result of this offset, the rotor is thus lifted at maximum upward in the axial direction in relation to the axially upper surface of the stator housing, that is to say further away from the second end of the stator in the axial direction. As a result of this maximum lifting of the rotor in the axial direction, the rotor can be configured more compactly, as a result of which the stability of the levitation of the rotor in the stator is improved.

This is advantageous precisely when the magnetic levitation device is intended for the levitation of rotors on which at least one vane is arranged. Such rotors are used, for example, for use as a pump and/or mixer of a fluid. If the rotor has the maximum lifting in such an application, the at least one vane can have a smaller extent in the axial direction, as a result of which forces acting on the vane or rotor further upward precisely in the axial direction are prevented. As a result, tilting moments are reduced and the levitation of the rotor is ensured well and reliably.

It is likewise possible in the case of centrifuges, rotary filters or cross-flow fans that two magnetic levitation devices according to the disclosure or a combination of a magnetic levitation device according to the disclosure with another magnetic levitation device can be used for the joint levitation of a rotor at both rotor ends. In these applications, too, the rotor can advantageously be of short configuration as a result of the magnetic levitation device according to the disclosure, which additionally advantageously increases the flexural resonance frequency of the rotor and displaces it from the range of the operating frequencies.

Furthermore, this conical configuration of the at least one concentrated winding is advantageous for the compactness of the magnetic levitation device. As a result, it is possible to be able to arrange the coil cores more flexibly. For example, the individual pole pieces and their connecting legs and the windings arranged thereon can be arranged closer to one another, which ensures an improvement in the magnetic flux conduction between stator and rotor.

In a preferred embodiment, the pole piece is produced from a soft-magnetic material.

In this case, it is preferred for the pole pieces to be produced from electrical sheet metal. According to the general definition, an electrical sheet metal is understood to mean a soft-magnetic material for magnetic cores. Soft-magnetic materials are usually referred to as materials which have a low 20 coercive field strength. The coercive field strength is that magnetic field strength which is required in order to demagnetize a substance. In the context of this application, a soft-magnetic material is understood to mean a material which has a coercive field strength, more precisely a coercive field strength of the magnetic polarization, which is less than 2′000 A/m. Further suitable soft-magnetic materials are, for example, ferromagnetic or ferrimagnetic materials, that is to say in particular iron, nickel-iron, cobalt-iron, silicon-iron or Mu metal.

It is likewise possible to produce the connecting legs and also the back iron from soft-magnetic materials.

In a preferred embodiment, the pole piece is produced in a laminated manner from pole elements, wherein the pole elements are stacked in the axial direction.

Furthermore, it is preferred that each connecting leg is produced in a laminated manner from elements, wherein the elements are stacked in the circumferential direction of the stator.

One advantage of the laminated configuration is that it ensures a reduction of the eddy current losses in the respective component (back iron, connecting leg, pole piece).

Most eddy current losses occur at the pole pieces since the distance between adjacent pole pieces, in particular at the ends thereof which face the cup-shaped recess, is particularly small. The fields initially emerge in the radial direction at the pole piece. Eddy currents are effectively reduced by the stacking of the elements of the respective component. The fields of two pole pieces which are adjacent in the circumferential direction of the stator also emerge therefrom in the circumferential direction. Therefore, a stacking of the respective elements must be selected in order to be able to effectively prevent eddy currents also in the circumferential direction. This is ideally possible in the case of the pole pieces by the stacking of the pole elements in the axial direction. Likewise, as an alternative, the pole piece can be produced from soft-magnetic materials (e.g., <<soft magnetic composite>>, <<SMC>> for short). This ensures a similar effect. Overall, these embodiments lead to the eddy current losses being drastically reduced. This results in a further important advantage. The end faces of the pole pieces can be arranged significantly closer to one another in the circumferential direction since fields which flow in the circumferential direction from the pole piece of a first coil core to the pole piece of a second, adjacent coil core flow parallel to the pole elements which are stacked in the axial direction and therefore do not generate eddy current losses. Therefore, for example, the passive stiffness and the active levitation forces can be improved and/or a more compact construction of the stator is possible.

The change in the orientation of the laminated configuration between the individual components (back iron, connecting leg, pole piece) once again ensures a further reduction of the eddy current losses of the entire magnetic levitation device.

In preferred embodiments, the back iron elements are laminated axially (that is to say stacked in the axial direction), the connecting leg which is arranged on the back iron then has elements which are stacked in the circumferential direction and the pole piece which is arranged thereon in turn has axially stacked pole elements. This arrangement and the change in the orientations ensure that the losses in the magnetic levitation device are reduced.

The elements of the connecting legs which are stacked in the circumferential direction have the advantage that lower losses occur here and the magnetic resistance is reduced in comparison with a stacking of the elements of the connecting legs in the axial direction. The reason for this is that, in the case of the elements which are stacked in the circumferential direction, the magnetic field does not have to pass through the lamination planes in the axial direction. That is to say, conversely, if the connecting leg were laminated in the axial direction, the magnetic field would have to flow in the axial direction through the boundaries between adjacent lamination planes and would both generate losses and experience an increased magnetic resistance.

Furthermore, it is possible that the pole piece and/or the connecting leg are produced from a powder composite material, in particular a soft-magnetic powder composite material. In this case, these materials, in English referred to as “soft magnetic composite (SMC)”, can be high-purity iron powder with a special surface coating. The special surface coating is electrically insulating in this case. SMCs are known primarily for their application in the conduction of high-frequency magnetic fields (frequency >>1 kHz). However, an application at lower frequencies has not been known hitherto. A lower frequency means frequencies which are less than 65 Hz.

Further advantages of the soft-magnetic powder composite materials are that they have a very good capability for three-dimensional flux conduction and have a high electrical resistance and a high permeability and thus have virtually no eddy current losses. Precisely the capability for three-dimensional flux conduction, without high eddy current losses being generated in the process, ensures that preferably soft-magnetic powder composite materials are used for the pole piece and/or the connecting leg.

Since soft-magnetic powder composite materials have comparatively high hysteresis losses, in some embodiments soft-magnetic powder composite material is used for producing the pole pieces and/or connecting legs. As a result, a balanced means is found between the reduction of the eddy current losses at the points at which they are particularly large and the undesired influence of the powder composite material on the magnetic circuit.

The attachment of a pole piece to a connecting leg and the attachment of the connecting leg to the back iron can be carried out by several possible types of joining. These include, inter alia, a force-fitting type of joining, such as, for example, clamping or crimping, a form-fitting type of joining, such as, for example, screwing or plugging, or a material-bonded connection, such as, for example, adhesive bonding or welding. It is likewise possible to produce the connections via tongue-and-groove connections and/or bung connections, such as, for example, pins, prongs or dovetail connections. In a preferred embodiment, the material-bonded type of joining is implemented by adhesive bonding. This has the advantage over clamping or screwing that no excessive stresses occur in the powder composite material. In addition, the force-fitting and form-fitting types of joining have the advantage that they have a low susceptibility to defects which occur, for example, as a result of ageing or defects during adhesive bonding.

In a preferred embodiment, the end face of the pole piece is designed as a curved surface. It is particularly preferred here that the curvature or the rounding of the end face is designed coaxially with respect to the cup-shaped recess. In other words, the end face of the pole piece is a segment of a cylinder surface, wherein the central axis of this cylinder coincides with the central axis of the cup-shaped recess and the radius of which is greater than that of the cup-shaped recess, with the result that the end face does not project into the cup-shaped recess.

In a preferred embodiment, the end face is designed to be wider with respect to the circumferential direction than the maximum extent of the contact surface in the circumferential direction. That means that one of the two edges of the end face which extend in the circumferential direction is longer than one of the edges of the contact surface which extend in the circumferential direction. If the end face is designed as a curved surface, the length of one of the circular arcs of the segment of the cylinder surface in the radial plane is greater than the length of one of the edges of the contact surface which extend in the circumferential direction.

This widening of the end face in the circumferential direction has the advantage that the magnetic functionality is promoted as a result. For example, the passive stiffness and the active levitation forces can be improved.

According to a further preferred embodiment, the end face is designed to be narrower with respect to the circumferential direction than the maximum extent of the contact surface in the circumferential direction. That means that one of the two edges of the end face which extend in the circumferential direction is shorter than one of the edges of the contact surface which extend in the circumferential direction.

According to a preferred embodiment, the end face has a shape transition, preferably a rounding off or a step, at an edge which constitutes the transition to the pole piece surface. In other words, the edge which is located at the axially upper end of the end face of the pole piece and likewise represents the radially inner edge of the pole piece surface has a shape transition. On the one hand, a shape transition can be understood to mean that the transition from the end face to the pole piece surface has a radius at the edge. It can also be said that the edge is broken. If the pole piece is configured in a laminated manner from pole elements which are stacked in the axial direction, the pole piece can likewise have a shape transition. In this case, in addition to the shape transitions just mentioned, a shape transition can also be understood to mean that at least one of the pole elements which are located at the axially upper end of the pole piece has a smaller extent in the radial direction than the other elements. In other words, this at least one pole element is set back with respect to the other pole elements as seen in the radial direction from the rotor, that is to say that it is at a greater distance from the rotor than the other pole elements.

According to a preferred embodiment, the end face has at least one slot which extends in the axial direction. That is to say, in other words, that the at least one slot can extend in the axial direction in any length in the end face.

Furthermore, it is preferred that several slots are arranged parallel or approximately parallel to one another in the end face.

The arrangement of the several slots parallel to one another is advantageous since they are thereby also arranged parallel or at least approximately parallel to the course of the magnetic field, with the result that they do not block the latter.

Furthermore, it is preferred that the at least one slot extends from the pole piece surface to the pole piece bottom surface. This extent would thus be the maximum possible extent of a slot in the end face in the axial direction.

For a possible embodiment in which the end face has more than one slot, it is possible that one slot extends from the pole piece bottom surface in the axial direction and a second slot extends from the pole piece surface in the axial direction opposite the first slot. In this case, it is possible that the two slots each have an extent in the axial direction which is less than 50% of the extent of the end face in the axial direction. That is to say that, in other words, the end face has two slots which do not touch one another in the center of the end face and thus at least one pole element of the pole piece is located there which is not captured by the slot.

The introduction of at least one slot into the end face of the pole piece constitutes electrical insulation. That is to say that the at least one slot ensures that the path of the eddy currents in the pole elements is interrupted and thus blocked. Eddy currents which result from magnetic fields emerging from the pole elements in the axial direction can thus be prevented or reduced. This has the consequence that only small eddy currents remain in the pole piece and the eddy current losses in the pole piece overall are drastically reduced.

The production of the slots can be carried out by various methods. These include, inter alia, mechanical methods, such as, for example, milling, punching or cutting, the latter also including the use of lasers and/or water jet cutters and/or wire erosion.

According to a particularly preferred embodiment, the stator of the magnetic levitation device is designed to generate a torque with which the rotor can be driven magnetically in a contactless manner for rotation about the axial direction.

Here, the stator is configured as a bearing and drive stator which is both the stator of the electrical drive and the stator of the magnetic levitation. With the electrical windings of the stator, it is possible to generate a magnetic rotary field which, on the one hand, exerts a torque on the rotor which brings about the rotation thereof about a desired axis of rotation and which, on the other hand, exerts an arbitrarily adjustable transverse force on the rotor such that the radial position thereof can be actively controlled or regulated.

Precisely with regard to the embodiment in which the magnetic levitation device is designed to generate a torque, the configuration with the wider end face is advantageous since the magnetic functionality is promoted as a result. For example, an increased torque can be generated, or the passive stiffness or the active bearing forces can be improved.

In a preferred embodiment, the magnetic levitation device comprises a plurality of sensors for determining the rotor position and/or the angle of rotation of the rotor. Preferably, a sensor is arranged between every second stator pole. The sensors can also be arranged at other positions of the magnetic levitation device. The number of sensors is preferably between 4-8, but there can also be more or fewer sensors present in the magnetic levitation device.

According to a preferred embodiment, the magnetic levitation device is designed as an electromagnetic rotary drive or as a mixing device or as a centrifuge or as a cross-flow fan or as a rotary filter or as a viscometer.

That is to say that the magnetic levitation device according to the disclosure can be configured or used for various fluid conveying units, such as those just mentioned. In this case, the fluid conveying unit comprises the rotor, wherein the rotor supplies energy to a fluid by rotation and thus sets it in motion.

Furthermore, an electromagnetic rotary drive, which is also referred to as a coupling motor, is proposed by the disclosure, wherein the electromagnetic rotary drive comprises a magnetic levitation device according to the disclosure, and a rotor with a disk-shaped or ring-shaped magnetically active core, wherein the rotor can be inserted into the cup-shaped recess, and wherein the rotor is designed as a rotor of the electromagnetic rotary drive.

Such electromagnetic rotary drives are also known by the term bearing-free motor. In this case, the term bearing-free motor means an electromagnetic rotary drive in which the rotor is levitated completely magnetically with respect to the stator, wherein no separate magnetic bearings are provided.

Furthermore, a pump unit for a magnetic levitation device according to the disclosure is proposed by the disclosure, wherein the pump unit comprises the rotor and the pump unit has a pump housing with an inlet and with an outlet for a fluid to be conveyed. The rotor is arranged in the pump housing, wherein the rotor has a plurality of vanes for conveying the fluid. The pump housing delimits a pump chamber, wherein the pump housing has a cover part and a base part. The base part has a cylindrical or conical cup for receiving the rotor, which cup can be inserted into the cup-shaped recess of the stator.

Further advantageous measures and embodiments of the disclosure emerge from the dependent claims.

### BRIEF DESCRIPTION OF THE DRAWINGS

In the following, the disclosure is explained in more detail on the basis of exemplary embodiments and on the basis of the drawing. The drawings show:

FIG. 1 is a perspective illustration of a magnetic levitation device known from the state of the art according to the temple construction.

FIG. 2 is a perspective illustration of a first exemplary embodiment of a magnetic levitation device according to the disclosure.

FIG. 3 is a schematic sectional illustration of the exemplary embodiment from FIG. 2.

FIG. 4 is a schematic sectional illustration of the exemplary embodiment from FIG. 2 with a stator housing.

FIG. 5 is a perspective illustration of a segment with a coil core arranged thereon and a concentrated winding from FIG. 2.

FIG. 6 is a schematic sectional illustration of the segment with a coil core arranged thereon and a concentrated winding from FIG. 5.

FIG. 7 is a perspective illustration of a second embodiment of a segment with a coil core arranged thereon.

FIG. 8 is a perspective illustration of a third embodiment of a segment with a coil core arranged thereon.

FIG. 9 is a plan view of a second exemplary embodiment of a magnetic levitation device according to the disclosure,

FIG. 10 is a schematic sectional illustration of the second exemplary embodiment from FIG. 9.

FIG. 11 is a perspective illustration of a further embodiment of a pole piece.

FIG. 12 is a sectional illustration of a magnetic levitation device according to the disclosure with a pump unit inserted therein.

FIG. 13 is a perspective sectional illustration of a magnetic levitation device according to the disclosure with a mixing unit inserted therein.

FIGS. 14A and 14B are schematic illustration of the wiring of a magnetic levitation device according to the disclosure for controlling and regulating it.

### DETAILED DESCRIPTION

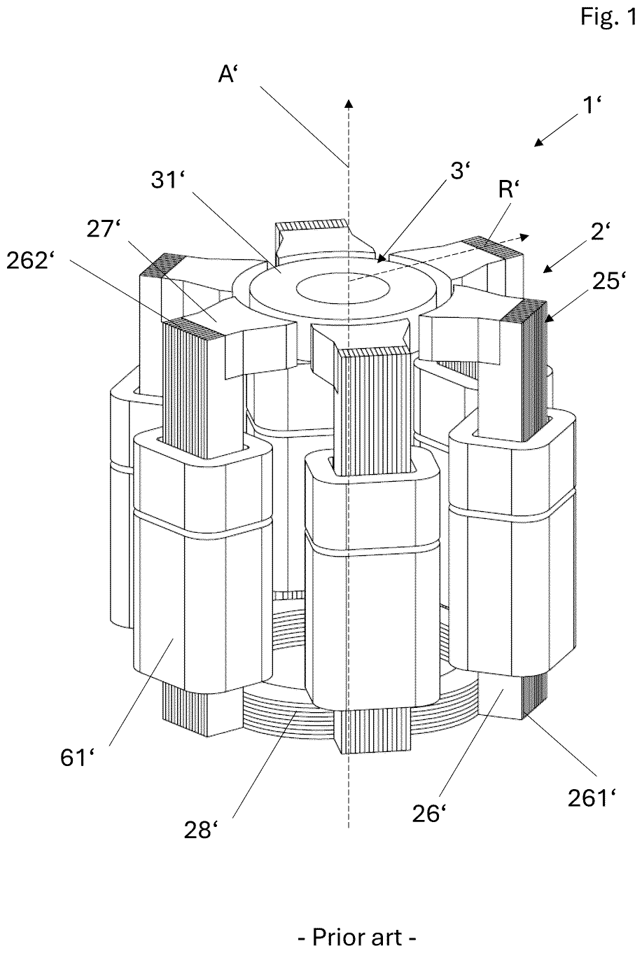

As already explained above, FIG. 1 shows a perspective illustration of a magnetic levitation device 1′ known from the state of the art according to the temple construction.

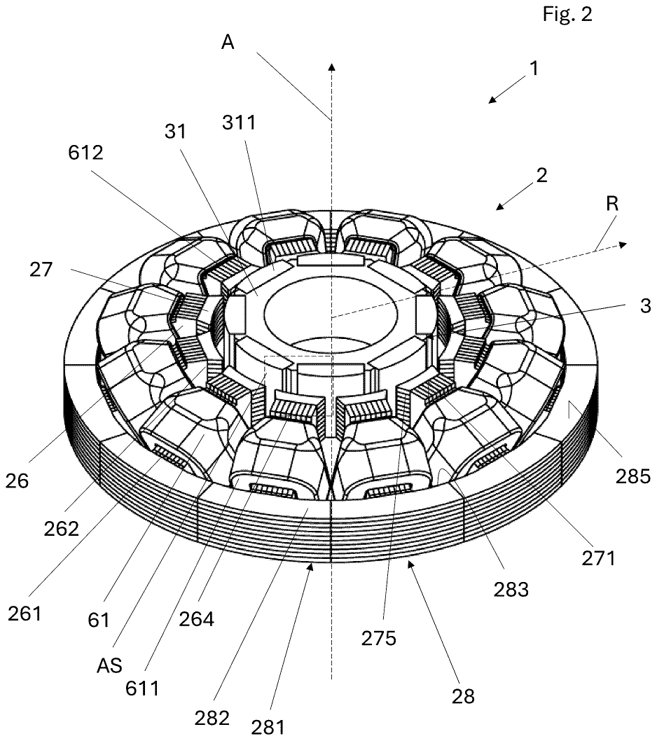

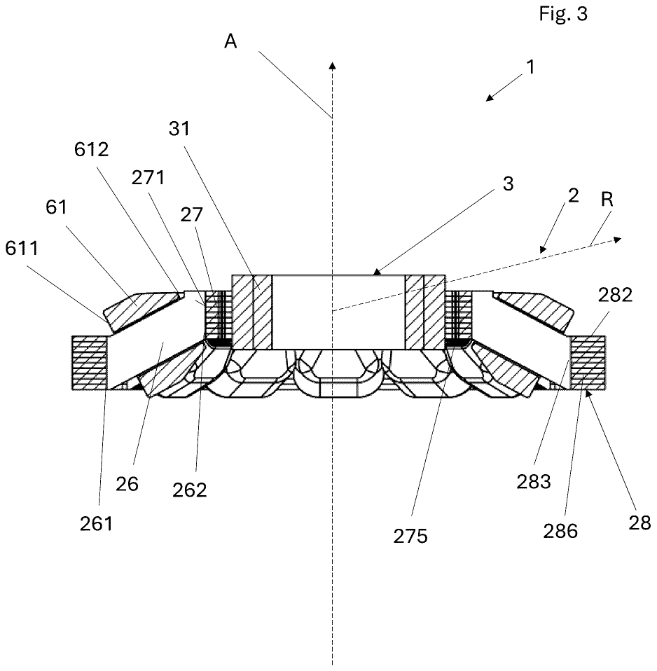

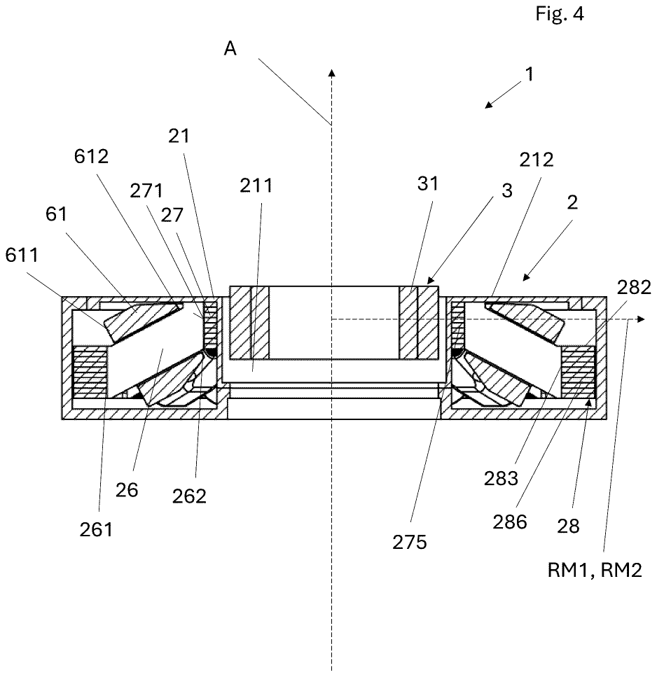

FIG. 2 shows a perspective illustration of a first exemplary embodiment of a magnetic levitation device according to the disclosure, which is denoted as a whole by the reference sign 1. FIG. 3 shows a schematic sectional illustration of the first exemplary embodiment from FIG. 2. The magnetic levitation device 1 is designed for the contactless magnetic levitation of a rotor 3 which comprises a disk-shaped or ring-shaped magnetically active core 31. The magnetic levitation device 1 comprises a stator 2. The stator 2 usually comprises a stator housing 21 (FIG. 4) which, however, is not illustrated in FIG. 2 for reasons of better clarity. Therefore, FIG. 4 illustrates in a schematic sectional illustration the exemplary embodiment from FIG. 2 with a stator housing 21. FIG. 4 is only intended to serve for the purpose of showing how an encapsulation of the interior of the stator 2 which is necessary for the operation of the magnetic levitation device 1 looks. For this reason, the other components of the stator 2 are only illustrated schematically and are to be understood in a purely illustrative manner.

During the operation of the magnetic levitation device 1 in regions in which, for example, chemically aggressive substances are used, it is important that the interior of the stator 2 is securely encapsulated and is thus protected from these substances. In order that a rotor 3 can nevertheless be used, the stator housing 21 has a cup-shaped recess 211 at an axial end, into which recess the rotor 3 can be inserted.

That part of the stator housing 21 which is located close to the concentrated windings 61 at the upper axial end AE1 of the stator 2 and that part of the stator housing 21 which faces the cup-shaped recess 211 are preferably manufactured from a low-loss material, particularly preferably from a material which is electrically non-conductive or only slightly conductive, such as, for example, plastics. The other parts of the stator housing 21 are preferably manufactured from a material with good thermal conductivity, such as, for example, aluminum.

The stator housing 21 is preferably hermetically sealed or, depending on the design of the housing 21, is already hermetically designed during production so that no substances harmful to the interior of the magnetic levitation device 1 can come into contact with the stator 2. Exemplary embodiments are also possible in which the housing 21 has coatings, e.g., one or more polymer coatings, which are chemically durable or resistant.

A cooling device can also be provided in the stator housing 21, which cools the magnetic levitation device 1, in particular the stator 2, and thus protects it from overheating.

The stator housing 21 can be filled with a casting compound which, on the one hand, fixes the stator 2 in a predetermined position and, on the other hand, contributes to the thermal regulation of the stator 2 or the magnetic levitation device 1.

The electronics for operating the magnetic levitation device 1 can either be arranged internally, i.e., inside the stator housing 21, or completely or partially externally, e.g., in a separate electronic component. The electronic component can, for example, be arranged away from the magnetic levitation device 1 and connected via one or more cables, or it can be attached to the outer wall of the housing 21, for example. Inter alia, the electronics contain not only all components for the levitation and drive of the rotor, but also, for example, for the sensor technology.

The rotor 3 is designed for rotation about a desired axis of rotation. This desired axis of rotation defines an axial direction A. The central axis of the stator 2 which extends in the axial direction A usually corresponds to the desired axis of rotation. In this case, the desired axis of rotation denotes that axis about which the rotor 3 rotates in the operating state when the rotor 3 is located in a centered and non-tilted position with respect to the stator 2, as is illustrated in FIG. 2.

The stator 2 has a plurality of coil cores 25—here 12 coil cores—, each of which has a connecting leg 26 and a pole piece 27. Each connecting leg 26 extends from a first end 261 to a second end 262. The first end 261 abuts a back iron 28. In this exemplary embodiment, the back iron 28 has several segments 281—here twelve segments 281—, an axial upper side 281 and a radial inner side 283. The number of segments 281 in this exemplary embodiment is purely exemplary. The back iron 28 can also include more or

less than twelve segments 281. In preferred exemplary embodiments, the number of coil cores 25 is equal to the number of segments 281, since a coil core 25 is always arranged on each segment 281.

The back iron 28 or, in this first exemplary embodiment, the segments 281 are produced in a laminated manner from back iron elements 286 which are stacked in the axial direction A.

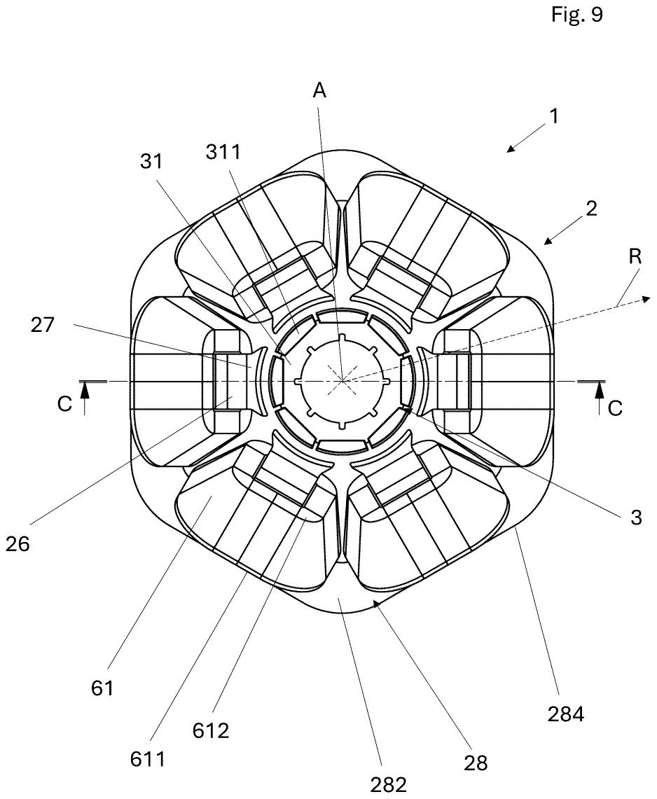

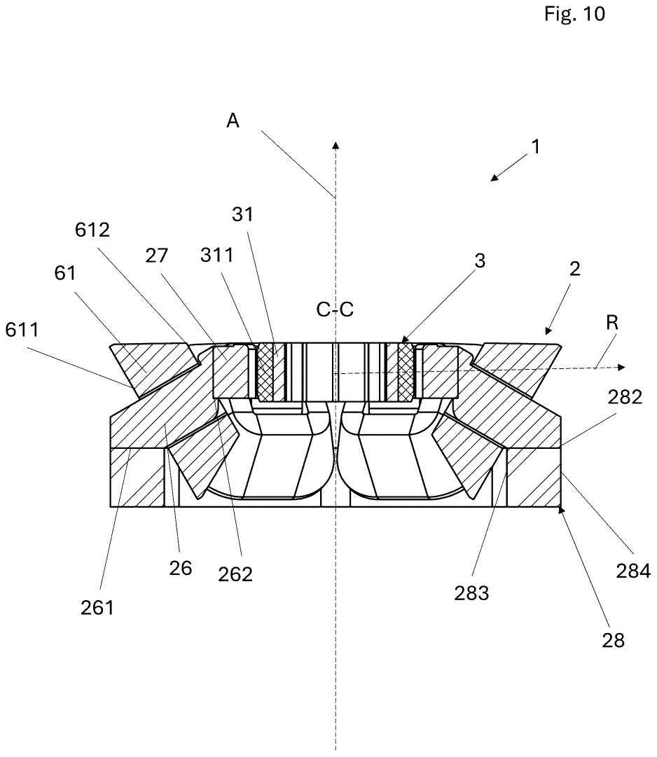

In this first exemplary embodiment, the first ends 261 of the connecting legs 26 are arranged on the radial inner side 283. Exemplary embodiments are also possible, wherein the first ends 261 of the connecting legs 26 are arranged on the axial upper side 281 (FIGS. 9 and 10).

Each pole piece 27 has a second contact surface 271 which abuts the second end 262 of the connecting leg 26. Each pole piece 27 extends from the second contact surface 271 in a radial direction R which is perpendicular to the axial direction A to an end face 272, wherein all end faces 272 are arranged around the cup-shaped recess 211.

There are intermediate spaces between adjacent pole pieces 27, wherein at least one sensor is introduced in at least one intermediate space. However, several intermediate spaces can also have at least one sensor, with the result that in some exemplary embodiments at least one sensor is arranged in each intermediate space. The at least one sensor can be provided, for example, for measuring the rotor properties, such as, for example, the position of the rotor, and/or for measuring stator properties, such as, for example, the temperature. The following types of sensors can be used for this purpose, inter alia: Hall sensors, eddy current sensors, optical sensors, capacitive sensors, temperature sensors. Combinations of the said sensors can likewise be provided. In all the exemplary embodiments shown, no sensors are illustrated for better clarity.

In the exemplary embodiment in FIG. 2, the end faces 272 of the pole pieces 27 are each designed as a curved surface. The rounding of the end faces 272 is designed coaxially with respect to the cup-shaped recess 211. In other words, the end faces 272 of the pole pieces 27 are a segment of a cylinder surface, wherein the central axis of this cylinder coincides with the central axis of the cup-shaped recess 211 and the radius of which is greater than that of the cup-shaped recess 211, with the result that the end faces 272 do not project into the cup-shaped recess 211. However, exemplary embodiments in which the end faces 272 have no rounding are also possible.

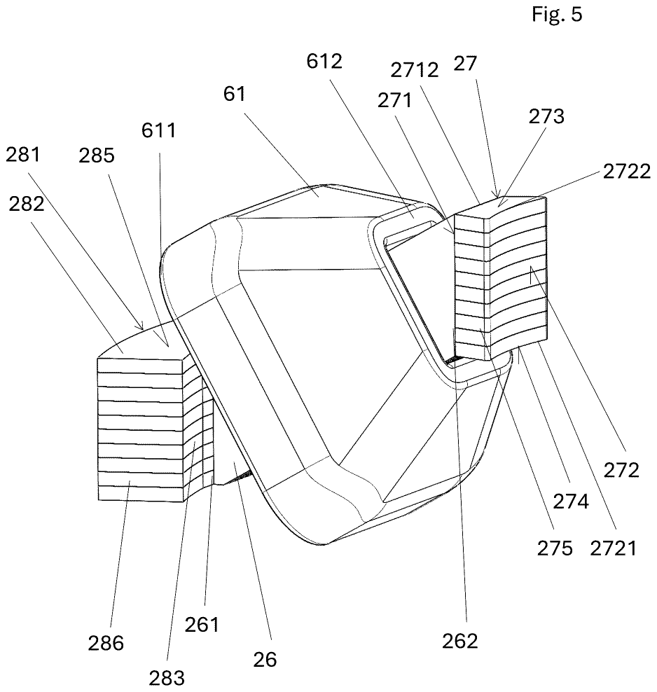

Furthermore, the end faces 272 in the first exemplary embodiment are designed to be wider with respect to the circumferential direction than the maximum extent of the contact surface 271 in the circumferential direction. That means that one of the two edges 2721, 2722 (FIG. 5) of the end face 272 which extend in the circumferential direction is longer than one of the edges 2711, 2712 (FIG. 5) of the contact surface 271 which extend in the circumferential direction. If the end face 272 is designed as a curved surface, the length of one of the circular arcs of the segment of the cylinder surface in the radial plane is greater than the length of one of the edges 2711, 2712 (FIG. 5) of the contact surface 271 which extend in the circumferential direction.

This widening of the end face 272 in the circumferential direction has the advantage since the magnetic functionality is promoted as a result. For example, the passive stiffness and the active levitation forces can be improved.

However, exemplary embodiments are also possible in which the end faces 272 are designed to be of the same width as the maximum extent of the contact surface 271 in the circumferential direction.

The segments 281 of the back iron are arranged adjacent to one another on a circular line, with the result that the pole pieces 27 connected to the segments 281 via the connecting legs 26 or the end faces 272 thereof surround the magnetically active core 31 of the rotor 3 when the rotor 3 is inserted into the cup-shaped recess 211.

Each connecting leg 26 extends obliquely with respect to the axial direction A, with the result that the second end 262 of each connecting leg 26 is at a smaller distance from the cup-shaped recess 211 in the radial direction R than the first end 261.

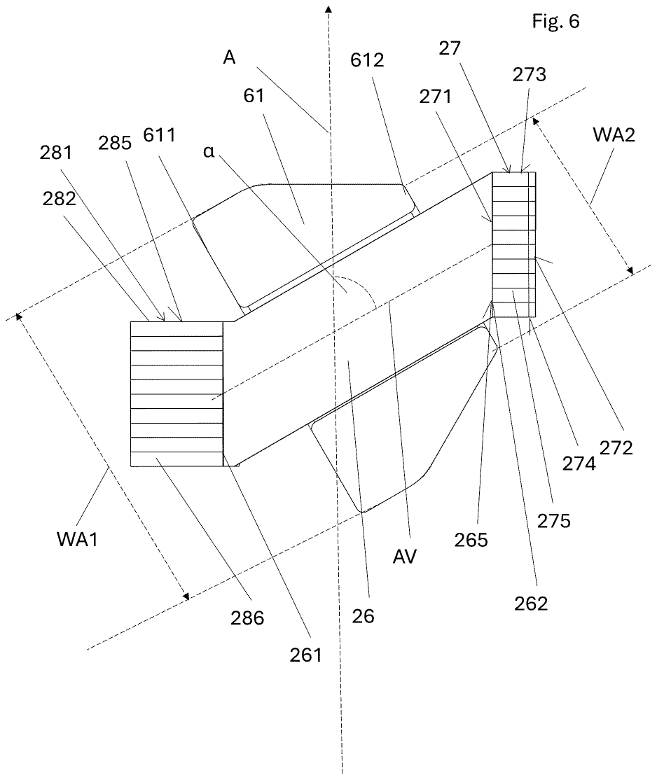

In other words, the connecting leg 26 has a radially inwardly directed extent. That is to say that the connecting leg 26 is oriented neither parallel nor perpendicular to the axial direction A. That is to say that an axis of the connecting leg AV (FIG. 6) encloses an angle α with the axial direction A which is greater than 0° and less than 90°. The angle α is preferably between 30° and 80°, and the angle α is particularly preferably between 45° and 75°. The axis AV of the connecting leg 26 which encloses the angle α with the axial direction A preferably extends from a first center point of the first contact surface 263 of the connecting leg 26 to a second center point of a second contact surface 265 (FIG. 6) of the connecting leg 26, wherein the second contact surface 265 is arranged on the contact surface 271 of the pole piece 27.

Furthermore, that means that the second end 262 of the connecting leg 26 is at a smaller distance from the cup-shaped recess 211 than the first end 261.

If the state of the art from FIG. 1 is now compared with the first exemplary embodiment of the magnetic levitation device 1 in FIG. 2, it can be seen directly that the magnetic levitation device 1 is configured significantly more compactly—in particular with respect to the axial direction A. A further advantage is that significantly more coil cores 25 can be arranged around the cup-shaped recess 211 in the magnetic levitation device 1 according to the disclosure. This ensures a wider covering, as seen in the circumferential direction, of that surface of the rotor 3 which faces the end faces 272 of the pole pieces 27 by the coil cores 25. A better flux conduction of the magnetic field is thus achieved.

At least one concentrated winding 61 is arranged on each connecting leg 26, which winding surrounds the respective connecting leg 26

The concentrated windings 61 serve for the purpose of generating electromagnetic fields with which the rotor 3 can be magnetically levitated in the cup-shaped recess 211 (FIG. 4) in a contactless manner.

In this exemplary embodiment, the concentrated windings 61 are of conical design.

For better understanding, a perspective illustration is shown in FIG. 5 and a schematic sectional illustration of a segment 281 with a coil core 25 arranged thereon and a concentrated winding 61 of the first exemplary embodiment from FIG. 2 is shown in FIG. 6. In other words, a concentrated winding 61 of conical design is understood to mean a winding 61, wherein the at least one concentrated winding 61 has a first outer diameter WA1 at the radially first end 611 and a second outer diameter WA2 at the radially second end 612, wherein the first outer diameter WA1 is greater than the second outer diameter WA2.

This is advantageous since a flat surface of the stator 2 is achieved at an axial end of the stator 2. Without the conical configuration of the concentrated winding 61, a flat surface would not be present since otherwise the at least one concentrated winding 61 would have an extent in the axial direction A which, as seen in the axial direction A, is higher than the extent of a pole piece surface 273 (FIGS. 5, 6) of the pole piece 27. In other words, the highest point in the axial direction A of the concentrated winding 61 must not exceed the highest point in the axial direction A of the pole piece 27. These two can lie at maximum in one and the same radial plane.

That is to say, a stator housing 21 which encloses the stator 2 thus has a flat surface at the axial upper end of the stator 2. In other words, the axially upper surface 212 (FIG. 4) of the stator housing 21 is located in a radial plane. This is advantageous for the magnetic levitation device 1 since a better interaction between stator 2 and rotor 3 is thereby achieved. The rotor 3 or the magnetically active core 31 has a radial central plane RM1 which, in the rest position, coincides with a radial central plane RM2 of the pole piece 27. This ensures that the levitation of the rotor 3 is ensured well and reliably.

Furthermore, this conical configuration of the at least one concentrated winding 61 is advantageous for the compactness of the magnetic levitation device 1. As a result, it is possible to be able to arrange the coil cores 25 more flexibly. For example, the individual pole pieces 27 and their connecting leg 26 and the windings 61 arranged thereon can be arranged closer to one another, which ensures an improvement in the magnetic flux conduction between stator 2 and rotor 3.

In this exemplary embodiment of the magnetic levitation device 1, the components (back iron 28 or segments 281, connecting leg 26 and pole piece 27) are all configured in a laminated manner from elements (264, 275, 286).

Here, the segments 281 are produced in a laminated manner from back iron elements 286, wherein the back iron elements 286 are stacked in the axial direction A. The connecting legs 26 are produced in a laminated manner from elements 264, wherein the elements 264 are stacked in the circumferential direction of the stator 2. The pole pieces 27 are produced in a laminated manner from pole elements 275, wherein the pole elements 275 are stacked in the axial direction A.

The number of elements (264, 275, 286) is to be understood in a purely exemplary manner in all exemplary embodiments and figures. The number can be greater or else smaller than illustrated.

The change in the orientation of the laminated configuration between the individual components (26, 27, 28 or 281) ensures a reduction of the eddy current losses of the entire magnetic levitation device.

The elements 264 of the connecting legs 26 which are stacked in the circumferential direction have the advantage that lower losses occur here, and the magnetic resistance is reduced in comparison with a stacking of the elements 264 of the connecting legs 26 in the axial direction A. The reason for this is that, in the case of the elements 264 which are stacked in the circumferential direction, the magnetic field does not have to pass through the lamination planes and in each case insulation between the lamination planes, in the axial direction A. That is to say, conversely, if the connecting leg 26 were laminated in the axial direction A, the magnetic field would have to flow in the axial direction A through the boundaries between adjacent lamination planes and would both generate losses and experience an increased magnetic resistance.

The orientations of the stacking of the respective elements (264, 275, 286) are based on this exemplary embodiment. A different orientation of the stacking of their respective elements (264, 275, 286) is also possible for all components (26, 27, 28 or 281). However, there is preferably a change in the orientation at the transition from one component (26, 27, 28 or 281) to the component (26, 27, 28 or 281) which is arranged thereon.

One advantage of the laminated configuration is that it ensures a reduction of the eddy current losses in the respective component (26, 27, 28 or 281).

Most eddy current losses occur at the pole pieces 27 since the distance between adjacent pole pieces 27, in particular at the ends thereof which face the cup-shaped recess 211, is particularly small. The fields initially emerge in the radial direction R at the pole piece 27. Eddy currents are effectively reduced by the stacking of the elements of the respective component (26, 27, 28). The fields of two pole pieces 27 which are adjacent in the circumferential direction of the stator 2 also emerge therefrom in the circumferential direction. Therefore, a stacking of the respective elements (264, 275, 286) must be selected which effectively prevent the emergence of the fields and the eddy currents connected thereto also in the circumferential direction. This is ideally possible in the case of the pole pieces 27 by the stacking of the pole elements 275 in the axial direction A. Likewise, as an alternative, the pole piece 27 can be produced from soft-magnetic materials (in English <<soft magnetic composite>>, <<SMC>> for short). This ensures a similar effect. Overall, these embodiments lead to the eddy current losses being drastically reduced. This results in the possibility, as can be seen in FIG. 2, that the pole pieces 27 can be arranged significantly closer to one another in the circumferential direction of the stator 2 and therefore several coil cores 25—here 12 in number—can be arranged in comparison with the temple motor from FIG. 1.

In preferred embodiments, the pole piece 27 is produced from a soft-magnetic material. In this case, it is preferred for the pole pieces 27 and/or the segments 281 and/or the connecting legs 26 to be produced from electrical sheet metal. The definition of an electrical sheet metal has already been described in previous sections. There is likewise the possibility of using Mu metal for producing the elements 264, 275, 286.

Further suitable soft-magnetic materials for the coil cores 25 and the back iron 28 are, for example, ferromagnetic or ferrimagnetic materials, that is to say in particular iron, nickel-iron, cobalt-iron, silicon-iron or Mu metal.

In other exemplary embodiments, the pole piece 27 and/or the connecting leg 26 can be produced from a powder composite material, in particular a soft-magnetic powder composite material (SMC). The definition and the advantages of this material have already been explained in previous sections.

According to a specifically preferred configuration, the stator 2 is designed such that, in addition to the contactless magnetic levitation of the rotor 3, it can also exert a torque on the rotor 3 or the magnetically active core 31 of the rotor 3 which drives the rotor 3 for rotation about a desired axis of rotation. That is to say, in this preferred embodiment, the rotor 3 can be driven for rotation about the axial direction A.

The already mentioned widening of the end face 272 in the circumferential direction has the advantage that the magnetic functionality is promoted as a result. For example, the passive stiffness and the active levitation forces can be improved. With regard to the embodiment in which the magnetic levitation device 1 is designed to generate a torque, there is additionally the advantage that an increased torque can be generated.

In this configuration, the concentrated windings 61 therefore generate electromagnetic rotary fields with which the rotor 3 can be levitated both magnetically in a contactless manner with respect to the stator 2 and can also be driven in a contactless manner for rotation about the axial direction A.

The rotor 3 comprises the magnetically active core 31 which is of ring-shaped or disk-shaped configuration. According to the illustration in FIG. 3, the magnetically active core 31 is designed as a ring and defines a magnetic central plane. Several individual magnets 311 (FIG. 2) are arranged on the magnetically active core. This is a so-called four-pole pair rotor 3. It goes without saying that rotors 3 with a number of pole pairs different from four, for example a single-pole pair rotor 3, can be used in other exemplary embodiments.

With respect to exemplary embodiments with the four-pole pair rotor 3 shown here, it is advantageous for the pole pieces 27 to be designed in a laminated manner stacked in the axial direction. If, in the operating state of the magnetic levitation device 1, a change between the individual magnets 311 of the rotor 3 takes place at a specific pole piece 27, that is to say as detail AS marked in FIG. 2, the magnetic field enters the pole piece 27 at a first point of the pole piece 27 and emerges from the same pole piece 27 again at a second point which is displaced in the circumferential direction. This flux conduction is possible with low losses only in the case of pole pieces 27 which are laminated and stacked in the axial direction. Pole are stacked in the circumferential direction would counteract the field course during the pole change here and lead to high losses.

If a soft-magnetic material (SMC) is used as material for the pole piece 27, the same advantages as just described occur. Likewise, SMC is also highly suitable for use for the four-pole pair rotor 3.

Alternatively, the magnetically active core 31 can also be designed as a disk. As a rule, in the case of a disk-shaped or ring-shaped magnetically active core 31, the magnetic central plane is the geometric central plane of the magnetically active core 31 of the rotor 3 which lies perpendicular to the axial direction A. In the operating state, the magnetically active core 31 is levitated in the radial plane which is perpendicular to the axial direction A.

Since it is sufficient for understanding the disclosure, only the magnetically active core 31 of the rotor 3 is illustrated in FIG. 2. It goes without saying that the rotor 3 can of course also include further components, such as, for example, casings or encapsulations which are preferably produced from a plastic, or from a metal or from a metal alloy or from a ceramic or a ceramic material. Furthermore, the rotor 3 can also include vanes for mixing, stirring or pumping fluids or other components.

When the rotor 3 is inserted into the cup-shaped recess 211 (FIG. 4), the rotor 3 and in particular the magnetically active core 31 of the rotor 3 is surrounded by the end faces 272, arranged radially on the outside, of the pole piece 27 of the coil cores 25 of the stator 2.

When the magnetically active core 31 of the rotor 3 is located in its desired position during operation, the magnetically active core 31 is centered between the end faces 272 of the pole pieces 27.

In order to generate the electromagnetic fields which are necessary for the magnetic levitation of the rotor 3 and optionally for generating a torque on the rotor 3, the connecting legs 26 carry the windings which are designed as concentrated windings 61.

With these concentrated windings 61, in the operating state, those electromagnetic rotary fields are generated with which an arbitrarily adjustable transverse force can be exerted on the rotor 3 in the radial direction, with the result that the radial position of the rotor 3, that is to say the position thereof in the radial plane perpendicular to the axial direction A, can be actively controlled or regulated. Optionally, a torque is additionally brought about on the rotor 3 with these electromagnetic rotary fields. Tilting of the rotor 3 can be passively stabilized by the ring-shaped or disk-shaped embodiment of the rotor 3. The diameter of the magnetically active core 31 of the rotor 3 is preferably at least twice as large as a core height of the magnetically active core 31, wherein the core height specifies the extent of the magnetically active core in the axial direction A.

The “magnetically active core 31” of the rotor 3 means that region of the rotor 3 which interacts magnetically with the stator 2 for the generation of the magnetic levitation forces and optionally for the torque formation.

As already mentioned, the magnetically active core 31 is of ring-shaped configuration in this exemplary embodiment and has several individual magnets 311 which are arranged on it. However, exemplary embodiments are also possible in which the magnetically active core 31 has no individual magnets 311 arranged on it. The magnetically active core 31 can then consist completely of a permanent-magnetic material, so that the magnetically active core 31 is the permanent magnet. The magnetically active core 31 is magnetized in the radial direction, for example.

Permanent magnets are usually referred to as those ferromagnetic or ferrimagnetic materials which are hard-magnetic, that is to say have a high coercive field strength. The coercive field strength is that magnetic field strength which is required in order to demagnetize a substance. In the context of this application, a permanent magnet is understood to mean a substance or a material which has a coercive field strength, more precisely a coercive field strength of the magnetic polarization, which is more than 10′000 A/m.

Preferably, the stator 2 and the rotor 3 have a predetermined pole number combination. The pole number of the stator 2 corresponds to the number of stator poles 25, while the pole number of the rotor 3 corresponds to the number of magnetic poles, in particular the number of permanent magnets. Preferred combinations of stator poles and magnetic poles are given in particular by the following pairs of numbers:

| stator poles | magnetic poles |
|---|---|
| 5 | 2 |
| 6 | 2 |
| 8 | 2 |
| 9 | 6 |
| 12 | 8 |
| 12 | 14 |
| 24 | 20 |
| 36 | 30 |

Embodiments in which the magnetically active core 31 is designed free of permanent magnets, that is to say without permanent magnets, are also possible. The rotor 3 is then designed, for example, as a reluctance rotor. The magnetically active core 31 of the rotor 3 then consists, for example, of a soft-magnetic material. Suitable soft-magnetic materials for the magnetically active core 31 are, for example, ferromagnetic or ferrimagnetic materials, that is to say in particular iron, nickel-iron, cobalt-iron, silicon-iron, Mu metal.

Furthermore, embodiments in which the magnetically active core 31 of the rotor 3 comprises both ferromagnetic materials and permanent-magnetic materials are possible. For example, permanent magnets can be placed or inserted into a ferromagnetic main body. Such embodiments are advantageous, for example, if, in the case of large rotors, it is intended to reduce the costs by saving permanent-magnetic material.

Embodiments in which the rotor is designed according to the principle of a cage rotor are also possible.

By contrast, the stator 2 is free of permanent magnets. By this designation that the stator 2 is designed “free of permanent magnets”, it is intended to be understood in the context of this application that the stator 2 does not comprise any permanent magnets which make a substantial contribution to the drive field for driving the rotation of the rotor 3 or for generating the magnetic levitation forces for the rotor 3. The generated magnetic flux by the stator 2 for the drive and the levitation of the rotor 3 therefore does not comprise any permanent-magnetically excited flux.

It is of course possible for the rotor 3 and/or the stator 2 to comprise other magnets or permanent magnets, for example in sensors which serve, for example, for detecting the angular position of the rotor, or which otherwise fulfil a purpose which has nothing to do with the generation of the magnetic flux for the drive and the levitation of the rotor 3.

The designation “free of permanent magnets” therefore relates only to the generation of the magnetic flux for the drive and the levitation of the rotor 3 by the stator 2. In other words, the stator 2 has no permanent magnets which make a contribution to the magnetic flux by which the rotor 3 is driven and levitated magnetically.

However, it is nevertheless possible for the magnetic flux for the drive and the levitation of the rotor 3 to comprise a permanent-magnetic flux, but this is then generated only by the rotor 3 itself. This would be the case if the rotor 3 itself comprises a permanent magnet.

During the operation of the magnetic levitation device 1, the magnetically active core 31 of the rotor 3 interacts with the stator 2 in such a way that the rotor 3 can be levitated magnetically in a contactless manner with respect to the stator 2, and can preferably additionally be set in rotation magnetically in a contactless manner about the axial direction A. In this case, it is particularly advantageous for the same windings 61 with which the magnetic levitation of the rotor 3 is brought about also to serve for the purpose of generating a torque on the rotor 3. Preferably, three degrees of freedom of the rotor 3, namely its position in the radial plane and its rotation, can then be actively regulated. With respect to its axial deflection out of the radial plane in the axial direction A, the magnetically active core 31 of the rotor 3 is stabilized passively magnetically, that is to say in a non-actuatable manner, by reluctance forces. The magnetically active core 31 of the rotor 3 is also passively magnetically stabilized with respect to the remaining two degrees of freedom, namely tilting with respect to the radial plane perpendicular to the desired axis of rotation. The rotor 3 is therefore passively magnetically levitated or passively magnetically stabilized by the interaction of the magnetically active core 31 with the coil cores 25 in the axial direction A and against tilting (a total of three degrees of freedom) and is actively magnetically levitated in the radial plane (two degrees of freedom).

As is generally customary, in the context of this application too, an active magnetic levitation denotes such a levitation which can be actively controlled or regulated, for example by the electromagnetic fields generated with the concentrated windings 61. A passive magnetic levitation or a passive magnetic stabilization denotes such a levitation which cannot be actuated or regulated. The passive magnetic levitation or stabilization is based, for example, on reluctance forces which bring the rotor 3 back into its desired position in the event of a deflection out of its desired position, that is to say e.g. in the event of a displacement or deflection in the axial direction A or in the event of a tilting.

In the magnetic levitation device 1, in contrast to conventional magnetic bearings, the magnetic levitation—and optionally the generation of a torque acting on the rotor—is realized by electromagnetic rotary fields. For the combined generation of the magnetic levitation forces and of a torque for rotating the rotor 3 about the axial direction A, it is possible on the one hand—as shown in FIG. 2—to arrange exactly one concentrated winding 61 on each connecting leg 26.

On the other hand, embodiments are also possible in which two different winding systems are provided for the combined generation of the magnetic bearing forces and of a torque for rotating the rotor 3. For this purpose, for example, exactly two concentrated windings which are arranged adjacent to one another are then arranged in each case on each connecting leg 26. That is to say one of the concentrated windings is arranged closer to the first end 261 and the other is arranged closer to the second end 262 of the connecting leg 26. One of these two windings belongs to the first of the two winding systems and the other to the second of the two winding systems.

In the embodiment which is illustrated in FIG. 2 with exactly one concentrated winding 61 on each connecting leg 26, for example, the values which are determined in each case in a control unit for the current which is required for the levitation and the current which is required for the generation of the torque are added or superimposed computationally—that is to say for example with the aid of software. The total current which results from this is then impressed into the respective concentrated winding 61.

If the stator 2 of the magnetic levitation device 1 according to the disclosure is designed to generate a torque, the magnetic levitation device 1 is suitable for an electromagnetic rotary drive. It is likewise possible that the magnetic levitation device 1 according to the disclosure is also suitable for other devices such as, for example, centrifugal pumps, mixing devices for mixing flowable substances, stirring devices, for example for mixing a fluid in a tank, centrifuges, viscosity sensors, rotary filters, fans or else devices for carrying and rotating wafers, for example in semiconductor production.

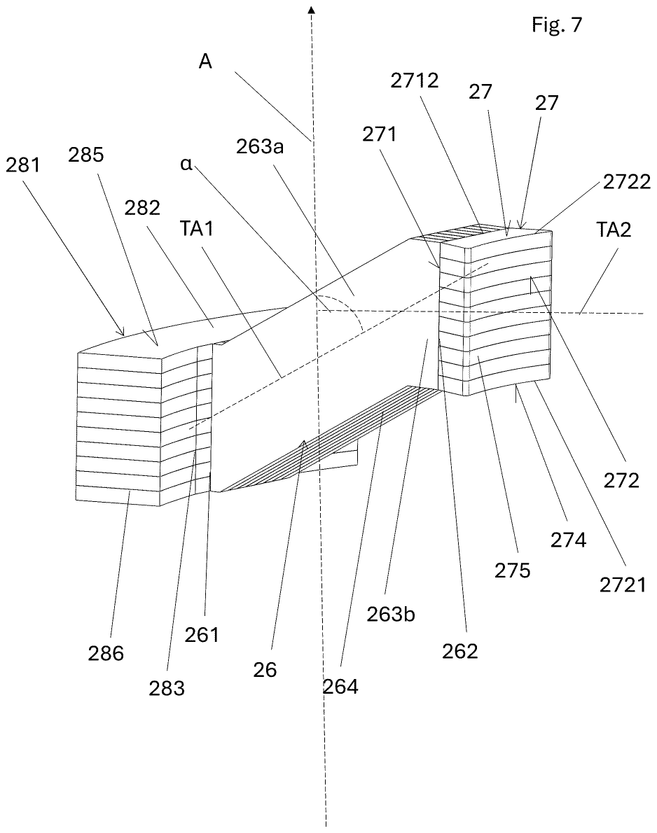

FIG. 7 shows a perspective illustration of a second embodiment of a segment 281 with a coil core 25 arranged thereon. In the following description of the second embodiment of a segment 281, only the differences with respect to the first embodiment from FIGS. 2-6 are explained in more detail.

The explanations with respect to the first embodiment also apply in the same way or analogously to the second embodiment. Identical reference signs denote the same features which have been explained with reference to the first embodiment, or functionally equivalent features. The main difference in this embodiment is that the connecting leg 26 has, before the second end 262, a part 263b which does not extend obliquely but rather in the radial direction R. The connecting leg 26 therefore has a first part 263a which extends obliquely, that is to say the central axis TA1 of which encloses an angle α with the axial direction A which is greater than 0° and less than 90°. The angle is preferably between 20° and 80°, particularly preferably the angle α is between 45° and 75°. Furthermore, the connecting leg 26 has a second part 263b, the central axis TA2 of which is perpendicular to the axial direction A.

This second embodiment can be advantageous, for example, if the diameter of the rotor 3 or therefore also of the cup-shaped recess 211 is intended to be smaller than in the first embodiment, but the external mass of the magnetic levitation device is not intended to be changed.

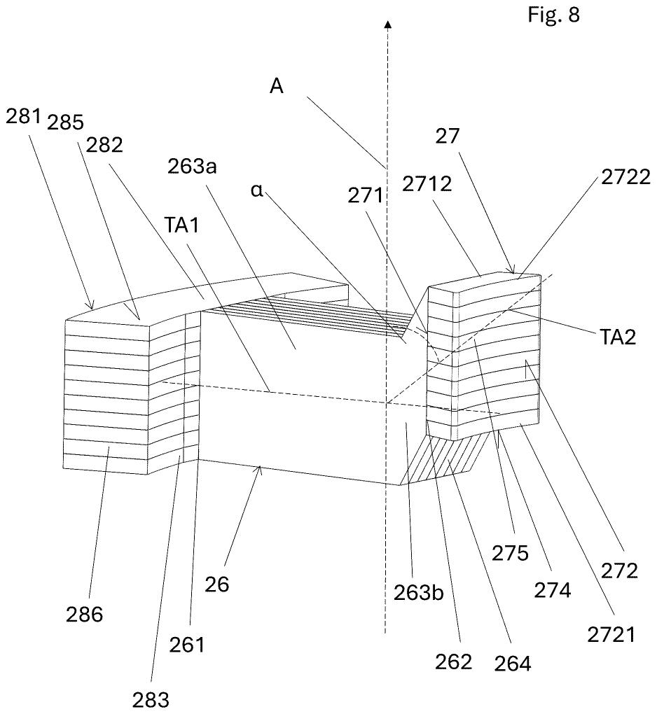

FIG. 8 shows a perspective illustration of a third embodiment of a segment 281 with a coil core 25 arranged thereon. In the following description of the third embodiment of a segment 281, only the differences with respect to the first and second embodiments from FIGS. 2-6 and 7 are explained in more detail. The explanations with respect to the first and second embodiments also apply in the same way or analogously to the third embodiment. Identical reference signs denote the same features which have been explained with reference to the first and second embodiments, or functionally equivalent features.

In the third embodiment, the main difference is that the first part 263a extends in the radial direction R and the second part 263b extends obliquely. That is to say that the central axis TA1 of the first part 263a is perpendicular to the axial direction A and the second part 263b has a central axis TA2 which encloses an angle α with the axial direction A which is greater than 0° and less than 90°. The angle is preferably between 20° and 80°, particularly preferably the angle α is between 30° and 60°.

The third embodiment is advantageous if, for example, a magnetic levitation device 1 which is compact in the axial direction A is intended to be achieved. As a result of this arrangement, the entire magnetic levitation device 1 can be of flatter configuration in the axial direction A. Rather, with the third embodiment, it is also not necessary for the at least one concentrated winding 61 (not illustrated in FIG. 8) to be of conical design, but rather it can have a rectangular shape since, in this third embodiment, it would surround only the first part 263a of the connecting leg 26. With this embodiment, it is thus possible, without adaptation of the shape of the concentrated winding 61, for the stator 2 or the stator housing 21 to have a flat surface 212 and thus all the advantages of a flat surface 212 of the stator housing 21 which are mentioned in the previous description are achieved.

FIG. 9 shows a plan view of a second exemplary embodiment of a magnetic levitation device 1 according to the disclosure, and FIG. 10 shows a schematic sectional illustration of the second exemplary embodiment from FIG. 9. In the following description of the second exemplary embodiment of the magnetic levitation device 1, only the differences with respect to the first exemplary embodiment from FIG. 2 are explained in more detail. The explanations with respect to the first exemplary embodiment also apply in the same way or analogously to the second exemplary embodiment. Identical reference signs denote the same features which have been explained with reference to the first exemplary embodiment, or functionally equivalent features.

The main difference with respect to the first exemplary embodiment is that the first ends 261 of the connecting legs 26 are arranged on the axial upper side 282 of the back iron 28. Furthermore, the back iron 28 is not divided here into segments 281. The back iron 28 further has a hexagonal outer shape.

In this exemplary embodiment, the back iron 28 is preferably designed as a tape wound toroidal core. Tape wound toroidal cores are usually provided for use in transformers and inductances. The production of the tape wound toroidal cores is significantly simpler since this is a metallic tape which is wound up like a roll of adhesive tape. This means that a tape wound toroidal core has several tape windings. There is therefore the possibility of producing more cost-effective magnetic levitation devices 1.

Furthermore, the use of a tape wound toroidal core as a back iron 28 in this exemplary embodiment is advantageous since eddy current losses can thereby be avoided.

Since the tape windings are arranged perpendicular to the radial direction R, the magnetic field passes from the connecting legs 26 in the axial direction A into the back iron 28 and thus parallel to the tape windings. This means that the magnetic field does not penetrate any of the tape windings in the radial direction R, as a result of which eddy current losses are avoided.

In the second exemplary embodiment, six coil cores 25 are arranged on the back iron 28. Ideally, the number of coil cores 25 is equal to the number n of the n-sided polygon which represents the outer shape of the back iron 28. However, embodiments are also possible, in which the back iron 28 is of ring-shaped configuration.

On the back iron 28, the connecting legs 26 are arranged at the first end 261 flush with the radial inner side 283 and a radial outer side 284. The connecting leg 26 then extends obliquely, radially inwards as far as the second end 262, where the pole piece 27 is arranged. A compact magnetic levitation device 1 is thus also achieved in this exemplary embodiment. As a result of the arrangement of the coil cores 25 on the axial upper side 282 of the back iron 28, the magnetic levitation device 1 also becomes more compact in terms of its extent in the radial direction R since the back iron 28 does not have an additional extent in the radial direction R beyond the extent of the coil cores 25.

The concentrated windings 61 are again of conical design in order that the already described advantage of the flat surface 212 (FIG. 4) of the stator housing 21 is ensured.

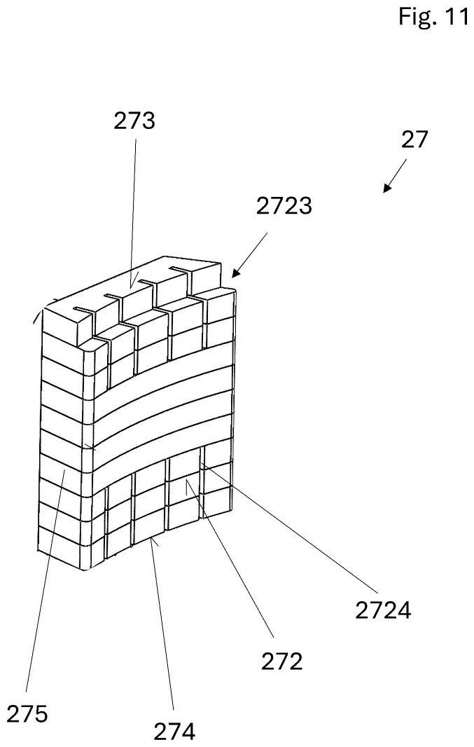

FIG. 11 shows a perspective illustration of a further embodiment of a pole piece 27.

One difference of this embodiment is that the end face 272 has a shape transition 2723, here designed as a step, at an edge 2722 (FIG. 7) which constitutes the transition to the pole piece surface 273. In other words, the edge 2722 which is located at the axially upper end of the end face 272 of the pole piece 27 and likewise constitutes the radially inner edge of the pole piece surface 273 has a shape transition 2723.

Since the pole piece 27 is designed in a laminated manner from pole elements 275 which are stacked in the axial direction A, the shape transition 2723 is designed in such a way that at least one of the pole elements 275 which are located at the axially upper end of the pole piece 27 has a smaller extent in the radial direction R than the other pole elements 275. In other words, this at least one pole element 275 is set back with respect to the other pole elements 275 as seen in the radial direction R from the rotor 3, that is to say that it is at a greater distance from the rotor 3 than the other pole elements 275.

However, a shape transition 2723 can likewise be understood to mean that the transition from the end face 272 to the pole piece surface 273 has a radius at the edge 2721. The edge 2721 can thus also be broken.

A further difference with respect to this embodiment is that the end face 272 has several slots 2724 which extend in the axial direction A.

A first number of slots 2724, more precisely four pieces, extend from the pole piece bottom surface 274 in the axial direction A and a second number of slots 2724, here likewise four, extend from the pole piece surface 273 in the axial direction A opposite the first number of slots 2724. The two numbers of slots 2724 do not touch one another in the center of the end face 272, as a result of which several pole elements 275 are not captured by the slots 2724. However, embodiments in which the slots 2724 extend over all pole elements 275 are also possible. The number of slots 2724 in this embodiment is to be understood in a purely exemplary manner, it can likewise be more or less.

In this embodiment, the slots 2724 are arranged parallel or approximately parallel to one another in the end face 272. The arrangement of the several slots 2724 parallel to one another is advantageous since they are thereby also arranged parallel or at least approximately parallel to the course of the magnetic field, with the result that they do not block the latter.

The introduction of slots 2724 into the end face 272 of the pole piece 27 constitutes an electrical insulation. That is to say that the slots 2724 ensure that the path of the eddy currents in the pole elements 275 is interrupted and thus blocked. Eddy currents which result from magnetic fields emerging from the pole elements 275 in the axial direction A can thus be prevented. This has the consequence that only small eddy currents remain in the pole piece 27 and the eddy current losses in the pole piece 27 overall are drastically reduced.

The production of the slots 2724 can be carried out by various methods. These include, inter alia, mechanical methods, such as, for example, milling, punching or cutting, the latter also including the use of lasers and/or water jet cutters and/or wire erosion.

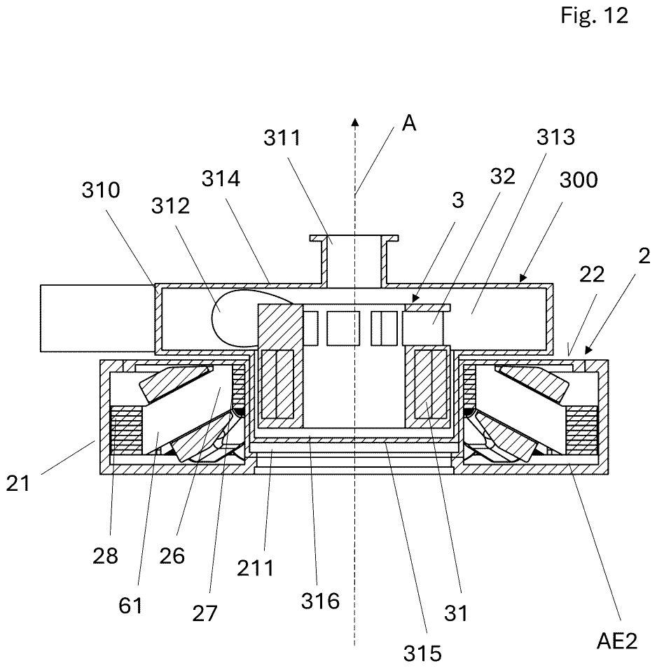

FIG. 12 shows a sectional illustration of a magnetic levitation device according to the disclosure with a pump unit inserted therein.

A pump unit 300 is inserted into the magnetic levitation device 1 from the first exemplary embodiment (FIG. 2) in FIG. 12, the pump unit 300 comprising the rotor 3. It goes without saying that the pump unit 300 can also be inserted into the magnetic levitation device 1 from the second exemplary embodiment (FIG. 9). The pump unit 300 comprises a pump housing 310 with an inlet 311 and with an outlet 312 for a fluid to be conveyed. The rotor 3 is arranged in the pump housing 310 and has a plurality of vanes 32 for conveying the fluid. The pump housing 310 delimits a pump chamber 313. Furthermore, the pump housing 310 has a cover part 314 and a base part 315, wherein the base part 315 has a cylindrical cup 316 for receiving the rotor 3. The cup 316 is thus inserted into the cup-shaped recess 211 of the stator 2.

On the basis of the illustration in this figure, it can be clearly seen why the offset between the back iron 28 or a back iron surface 285 and the pole piece 27 or the pole piece surface 273 is advantageous.

The pump unit 300 can be inserted into the cup-shaped recess 211 in a precisely fitting manner, with the result that a flat surface 22 of the stator housing 21 is achieved. Furthermore, as a result of the offset between the pole piece 27 and the back iron 28, the rotor 3 can be lifted at maximum upward in the axial direction A in relation to the axially upper surface 22 of the stator housing 21, that is to say further away from the second end AE2 of the stator 2 in the axial direction A. As a result of this maximum lifting of the rotor 3 in the axial direction A, the rotor 3 can be configured more compactly, as a result of which the stability of the levitation of the rotor 3 in the stator 2 is improved.

Precisely if the pump unit 300 or the rotors 3 are used for use as a mixer of a fluid, the vanes 32 can have a smaller extent in the axial direction A, as a result of which forces acting on the vane 32 further upward precisely in the axial direction A are prevented. As a result, tilting moments are reduced and the levitation of the rotor 3 is ensured well and reliably.

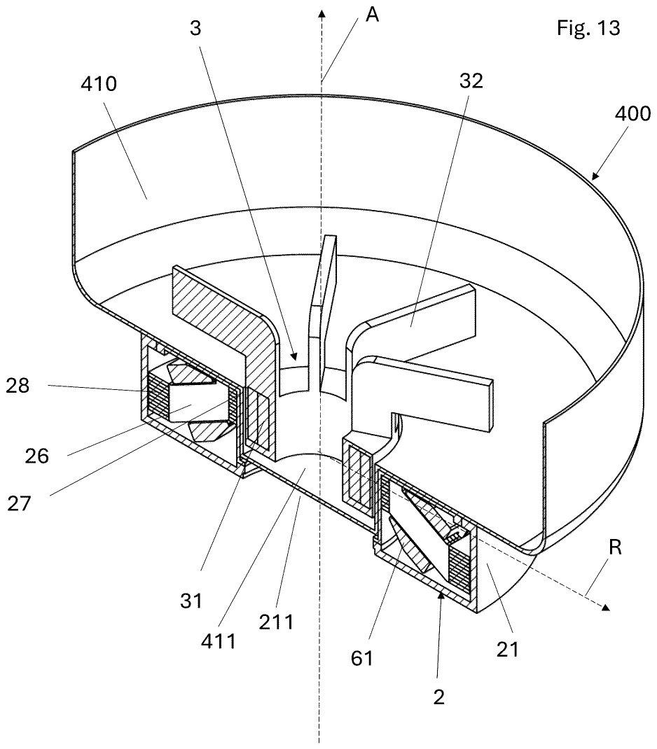

FIG. 13 shows a perspective sectional illustration of a magnetic levitation device according to the disclosure with a mixing unit 400 inserted therein.

In FIG. 13, a mixing unit 400 is inserted into the magnetic levitation device 1 according to the disclosure, wherein the mixing unit 400 comprises the rotor 3. The mixing unit 400 comprises a mixing container 410 (shown here only partially) which usually has an inlet and an outlet (not shown here, the inlet and outlet are often combined) for a substance to be mixed in, e.g., a fluid. The rotor 3 is arranged in the mixing container 410 and has a plurality of vanes 32 for mixing the substance. At the axially lower end of the mixing container 410, the latter has a cylindrical cup 411 for receiving the rotor 3. The cup 411 is thereby inserted into the cup-shaped recess 211 of the stator 2.

On the basis of the representation in this figure, it can be clearly seen why the offset between the back iron 28 or a back iron surface 285 and the pole piece 27 or the pole piece surface 273 is advantageous.

The mixing unit 400 can be inserted in a precisely fitting manner into the cup-shaped recess 211, such that a flat surface 22 of the stator housing 21 is achieved. Furthermore, as a result of the offset V between the pole piece 27 and the back iron 28, the rotor 3 can be lifted to the maximum extent upward in the axial direction A with respect to the axially upper surface 22 of the stator housing 21, that is to say further away from the second end AE2 of the stator 2 in the axial direction A. As a result of this maximum lifting of the rotor 3 in the axial direction A, the rotor 3 can be designed more compactly, as a result of which the stability of the levitation of the rotor 3 in the stator 2 is improved.

Precisely if the mixing unit 400 or the rotors 3 are used for use as a mixer of a fluid, the vanes 32 can have a smaller extent in the axial direction A, as a result of which forces acting on the vane 32 further upward in the axial direction A are prevented. As a result, tilting moments are reduced and the levitation of the rotor 3 is ensured well and reliably.

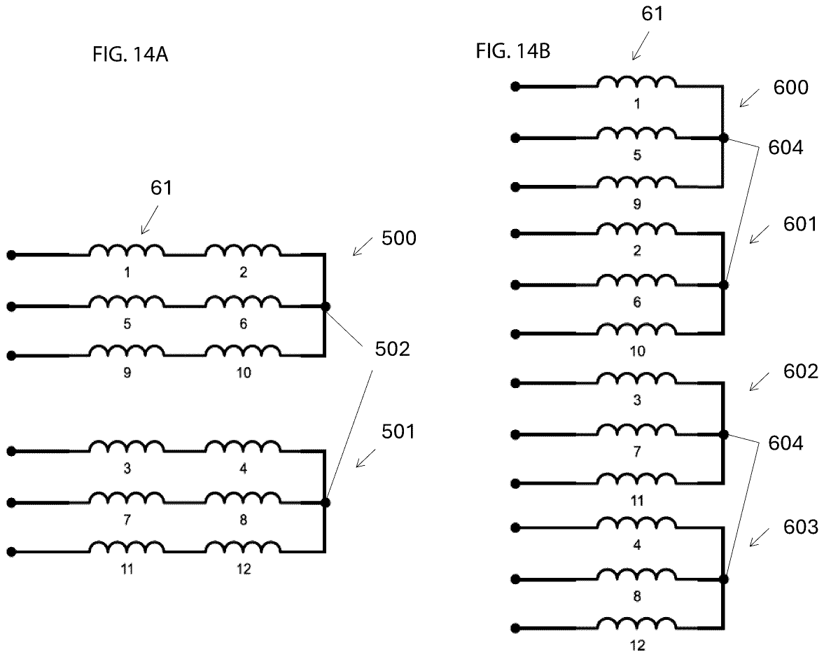

FIGS. 14A and 14B show schematic illustrations of the wiring of a magnetic levitation device 1 according to the disclosure for controlling and regulating it. In FIG. 14A, a 6-phase winding arrangement is shown, and in FIG. 14B, a 12-phase winding arrangement.

The winding arrangement in FIG. 14A comprises a first three-phase winding set 500 and a second three-phase winding set 501, wherein the two winding sets 500, 501 are designed to be electrically separated from each other and together form a six-phase wiring system. In this case, each winding set comprises six windings 61.

Each winding set 500, 501 is preferably designed as a star connection and has a respective star point 502 at which the associated windings 61 are connected to one another. Furthermore, each winding set 500, 501 comprises in each case two windings 61 connected in series, which form one phase, so that there is one series winding per phase. The windings 61 are connected in a preferred orientation to ensure a defined magnetic polarity and a symmetrical field distribution within the system.

In a preferred embodiment, the two windings connected in series are wired with opposite polarity, i.e., they have opposite winding directions.

The winding arrangement in FIG. 14B comprises four separate three-phase winding sets 600, 601, 602, 603, which together form a twelve-phase system.

Each of the four winding sets 600, 601, 602, 603 is preferably designed as a star connection and has in each case its own star point 604, at which the three associated windings 61 are electrically connected to one another. The star points 604 of the individual winding sets 600, 601, 602, 603 are particularly preferably electrically isolated from one another, so that a total of four separate star points 604 is formed.

Each winding set 600, 601, 602, 603 comprises three windings 61, wherein in each case one single winding 61 is provided per phase.

It goes without saying that all the exemplary embodiments shown in the description of the figures can be combined with one another in any form with their respective characteristics and components.

1. A magnetic levitation device for the contactless magnetic levitation of a rotor which has a disk-shaped or ring-shaped magnetically active core, the magnetic levitation device comprising:
a stator extending in an axial direction and having a cup-shaped recess arranged at an axial end of the stator and into which the rotor is configured to be inserted, the stator having a plurality of coil cores, each coil cord of the plurality of coil cords having a connecting leg and a pole piece, the connecting leg for each of the coil cords of the plurality of coil cords extending from a first end to a second end, the first end abutting a back iron,
for each of the coil cords of the plurality of coil cords, the pole piece having a second contact surface abutting the second end of the connecting leg, the pole piece extending from the second contact surface in a radial direction to an end face, the radial direction being perpendicular to the axial direction,
the end faces for the pole piece for the plurality of coil cords arranged around the cup-shaped recess and a concentrated winding arranged on the connecting leg for each of the coil cords of the plurality of coil cords, for each of the coil cords of the plurality of coil cords the concentrated winding surrounding the connecting leg, and extending obliquely with respect to the axial direction, such that the second end of the connecting leg is at a smaller distance from the cup-shaped recess in the radial direction than the first end.

2. The magnetic levitation device according to claim 1, wherein
the back iron connects the first ends of the connecting legs of the plurality of coil cords.

3. The magnetic levitation device according to claim 1, wherein
the back iron has several segments.

4. The magnetic levitation device according to claim 1, wherein
the back iron has an axial upper side and the first ends of the connecting legs of the plurality of coil cords are arranged thereon.

5. The magnetic levitation device according to claim 1, wherein
the back iron has a radial inner side and the first ends of the
connecting legs of the plurality of coil cords are arranged thereon.

6. The magnetic levitation device according to claim 1, wherein the concentrated winding arranged on the connecting leg for each of the coil cords of the plurality of coil cords is conical.

7. The magnetic levitation device according to claim 6, wherein
for each of the coil cords of the plurality of coil cords, the concentrated winding arranged on the connecting leg has a lower end and an upper end, the lower end facing the first end of the connecting leg and the upper end facing the second end of the connecting leg, the concentrated winding having a first outer diameter at the lower end and a second outer diameter at the upper end, the first outer diameter being greater than the second outer diameter.

8. The magnetic levitation device according to claim 1, wherein
for each of the coil cords of the plurality of coil cords, the pole piece is a soft-magnetic material.

9. The magnetic levitation device according to claim 1, wherein
for each of the coil cords of the plurality of coil cords, the pole piece is produced in a laminated manner from pole elements, the pole elements being stacked in the axial direction or the connecting leg is produced in a laminated manner from elements, the elements being stacked in a circumferential direction of the stator.

10. The magnetic levitation device according to claim 1, wherein
for each of the coil cords of the plurality of coil cords, the end face of the pole piece is a curved surface.

11. The magnetic levitation device according to claim 1, wherein
for each of the coil cords of the plurality of coil cords, the end face is wider with respect to a circumferential direction than a maximum extent of the second contact surface in a circumferential direction.

12. The magnetic levitation device according to claim 1, wherein for each of the coil cords of the plurality of coil cords, the end face has a rounding off at an edge which represents a transition to a pole piece surface.

13. The magnetic levitation device according to claim 1, wherein
the stator is configured to generate a torque with which the rotor is capable of being driven magnetically in a contactless manner for rotation about the axial direction.

14. The magnetic levitation device according to claim 13, wherein the magnetic levitation device is an electromagnetic rotary drive, mixing device, centrifuge, cross-flow fan, rotary filter or viscometer.

15. A pump unit, comprising:
the rotor;
a pump housing with an inlet and with an outlet for a fluid to be conveyed, the rotor arranged in the pump housing, the rotor having a plurality of vanes to convey the fluid, the pump housing delimiting a pump chamber and having a cover part and a base part, the base part having a cylindrical cup to receive the rotor,
the cylindrical cup configured to be inserted into the cup-shaped recess of the stator of the magnetic levitation device according to claim 1.

16. The magnetic levitation device according to claim 3, wherein
the several segments are produced in a laminated manner and stacked in the axial direction.

17. The magnetic levitation device according to claim 1, wherein
for each of the coil cords of the plurality of coil cords, the end face of the pole piece is a curved surface, the end face having a rounding configured coaxially with respect to the cup-shaped recess.
